(19) United States
(12) Patent Application Publication
(10) Pub. No.: US 2024/0095004 A1
(43) Pub. Date: Mar. 21, 2024

(54) METHOD FOR CONVERTING A MEASURING SYSTEM OF A FIRST TYPE TO A SECOND TYPE AND MEASURING SYSTEM

(71) Applicant: Endress+Hauser Conducta GmbH+Co. KG, Gerlingen (DE)

(72) Inventors: Stefan Kempf, Kornwestheim (DE); Stefan Robl, Hünxe (DE)

(21) Appl. No.: 18/470,004

(22) Filed: Sep. 19, 2023

(30) Foreign Application Priority Data
Sep. 21, 2022 (DE) 10 2022 124 166.1

(51) Int. Cl. G06F 8/61; G06F 8/71

(52) U.S. Cl. CPC G06F 8/61; G06F 8/71

(57) ABSTRACT

The present disclosure discloses a method for converting a measuring system of a first type to a second type. The measuring system includes two subsystems, namely a sensor and an end application, wherein each subsystem is designed to be app-capable, i.e., the firmware of each subsystem is designed to receive, install, and execute apps. The method includes the steps of creating sub-apps for the respective subsystem, where the sub-apps are specific to the measuring system of the second type, creating a multipart app comprising all the sub-apps, and installing the multipart app onto the measuring system.

### CROSS-REFERENCE TO RELATED APPLICATION

The present application is related to and claims the priority benefit of German Patent Application No. 10 2022 124 166.1, filed on Sep. 21, 2022, the entire contents of which are incorporated herein by reference.

### TECHNICAL FIELD

The present disclosure relates to a method for converting a measuring system of a first type to a second type. This is a measuring system in the field of process automation technology. The present disclosure further relates to a measuring system for executing the method.

### BACKGROUND

A measuring system today often no longer consists of a single component or a single device, but of a cluster of systems such as, for example, a sensor, the associated measuring transducer, possibly an edge device, a cloud connection and finally an end application with a visualization.

If such a measuring system is to be supplemented by a new functionality, it is usually not sufficient to change only one individual system. All devices in the cluster must be adapted. Performing this individually per unit is tedious and prone to errors.

### SUMMARY

The object of the present disclosure is to add a functionality to an entire cluster of subsystems without having to adapt each subsystem manually.

The measuring system comprises at least two subsystems, namely a sensor and an end application, wherein each subsystem is designed to be app-capable, i.e., the firmware of each subsystem is designed to receive, install and execute apps. Specifically, the object is achieved by the method comprising the steps of creating sub-apps for the respective subsystem, wherein the sub-apps are specific to the measuring system of the second type; creating a multipart app comprising all sub-apps; and installing the multipart app onto the measuring system.

In the following, the term “app” is used synonymously with the term “plug-in” and is a downloadable program code which brings a useful functionality.

There are two ways to distribute the multipart app: from a central system or from a subsystem. First, the distribution from the central system will be discussed.

One embodiment provides that the multipart app is installed from a central system and is distributed from there to the subsystems, in particular by a control system or a computer of the end user.

One embodiment provides that the multipart app is split by the central system into the sub-apps and the sub-apps are transmitted to the respective subsystems.

One embodiment provides that the multipart app is transmitted from the central system to a first subsystem, the first subsystem installs its sub-app, and forwards the multipart app to the second subsystem, where the respective sub-app is then installed, etc.

One embodiment provides that the first subsystem only forwards the non-installed part.

The distribution from a subsystem will now be discussed.

One embodiment provides that the multipart app is installed on a subsystem and is distributed from there to the other subsystems.

One embodiment provides that the installation takes place by means of memory card, in particular an SD card.

One embodiment provides that the sub-app of the subsystem on which the multipart app has been installed is installed on the same.

One embodiment provides that the multipart app is split into the sub-apps by the subsystem on which the multipart app was installed and the sub-apps are transmitted to the respective other subsystems.

One embodiment provides that the multipart app is transmitted from the subsystem on which the multipart app was installed to a further subsystem, this subsystem installs its sub-app, and forwards the multipart app to another subsystem, where the respective sub-app is then installed, etc.

One embodiment provides that the respective subsystem only forwards the non-installed part.

One embodiment provides that the sub-app is not installed again if it is already present on the corresponding subsystem in the same version as the newly installable one.

One embodiment provides that the multipart app comprises more sub-apps than there are subsystems.

One embodiment provides that a sub-app comprises at least one of the following tasks: signal processing, user interface for configuration and interaction, visualization, data transformation to a superordinate system, such as a fieldbus, establishing, processing or executing a computation model, filtering, etc.

The object is further achieved by a measuring system for executing the method as described above.

One embodiment provides that the measuring system comprises the sensor, measuring transducer, edge device, cloud and end application subsystems.

### BRIEF DESCRIPTION OF THE DRAWINGS

This is explained in more detail with reference to the following figures.

FIGS. 1a/b show a measuring system of a first type and a second type in an overview.

FIG. 2 shows a measuring system with a sensor, measuring transducer and further subsystems.

FIG. 3 shows a multipart app with sub-apps.

FIG. 4 shows the installation of the multipart app in one embodiment.

FIG. 5 shows the installation of the multipart app in another embodiment.

In Figures, the same features are labeled with the same reference signs.

### DETAILED DESCRIPTION

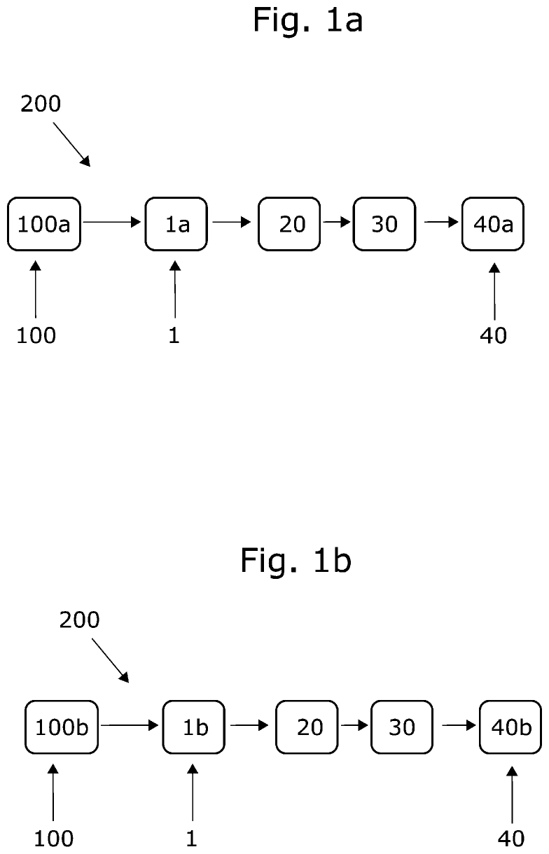

FIGS. 1a and 1b show a measuring system 200 of a first type and a second type in an overview. The measuring system 200 comprises at least two subsystems, namely a sensor 100 and an end application 40. The end application is designed, for example, as a unit with which measurements of the sensor 100 can be shown (see also below).

FIG. 1a/b shows a measuring system 200 with five subsystems, specifically a sensor 100, a measuring transducer 1, an edge device 20, a cloud 30 and an end application 40. A measuring system with fewer than five subsystems is possible. One example is an embodiment without a dedicated edge device 20 when the measuring transducer 1 is directly connected to the cloud 30. In one embodiment, the sensor 100 and the measuring transducer 1 are installed as a single device. An embodiment without a cloud 30 is also possible. In the following, the method will be described on the basis of the five subsystems; as mentioned, deviations are possible.

An end application 40 in the sense of this application is an application, the purpose of which is no longer the measurement itself, or which no longer passes along the measured values themselves. It is, for example, a subsystem with the main task of presenting the information to the end user, for example as a graphical user interface. In addition or instead, final data processing can also take place in an end application. For example, a targeted preprocessing takes place in the sensor, for instance in the sensor-side app, then the final processing together with visualization takes place in the measuring transducer 1 or the end application 40. A multipart app 2 (see below) contains these two apps and is then installed in a distributed manner on both subsystems during installation.

Even if an end application is embedded in further systems and the change in the app on the subsystem leaves higher-level embedded systems unaffected, the subsystem can be regarded as an end application.

In principle, the claimed measuring system has two ends as a chain of subsystems. A “source” in which a processing reconfigurable by app starts (for instance, a sensor 100) and ends (for instance, at the end application 40) in which the processing reconfigurable by app ends. Of course, the subsystems from source to sink can in turn be embedded in a larger overall system. However, if the switch of an app does not influence the configuration of the surrounding systems, the subsystem can be viewed as its own measuring system from the source to the end.

FIG. 1a shows the measuring system 200 of the first type. This is, for example, a production and filling plant for non-alcoholic carbonated beverages. The subsystems are configured such that the data that are relevant to the production are transmitted to the next subsystem. The measuring system 200 is coordinated with the sensor, measuring transducer, edge device, cloud and end application in order to monitor the production, to display the measured values on the on-site display 7 of a measuring transducer 1, to transmit the measured values from the measuring transducer 1 via an edge device 20 to the cloud 30, and to display them there in an end application 40, wherein the GUI (graphical user interface) of the end application 40 is tailored to the production of non-alcoholic beverages. The other subsystems are also optimized precisely for this application.

This measuring system 200 is now to be switched to a production and filling plant for alcoholic carbonated beverages, see FIG. 1b. In this case, other models (see below) of the sensors 100 are sometimes used, other computation operations are required in the measuring transducer 1, or another representation in the end application 40 is desired. Even if the same measuring transducer is used, it may need to be reconfigured. The various types are each marked with the letters “a” or “b” in FIG. 1a/b. In FIG. 1a/b, these are the sensor 1, measuring transducer 100 and the end application 40. The sensor 100a is thus specific to the measuring system 200 of the first type, the sensor 100b is thus specific to the measuring system 200 of the second type, etc. All subsystems can also be reconfigured or functions can be added.

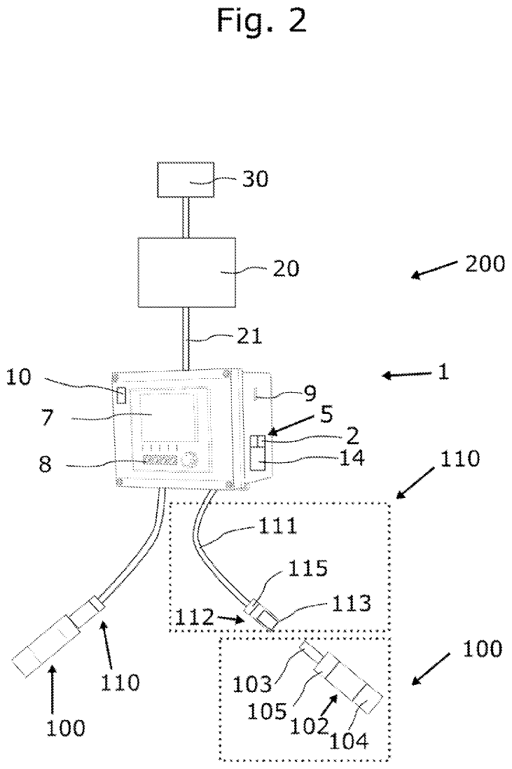

The sensor 100 and the measuring transducer 1 will now be briefly discussed with reference to FIG. 2.

Generally speaking, a measuring transducer 1, also called a transmitter, is a device that converts an input variable into an output variable according to a fixed relationship. In process automation technology, a field device, for example, is connected to a measuring transducer. “Measuring transducer” and “transmitter” are used synonymously herein. The field device is a sensor, for example. Its raw measured values are processed in the measuring transducer, e.g., averaged or converted by means of a computation model to another variable, for example, the process variable to be determined, and possibly transmitted, to a control system, for example.

A wide variety of sensors can be connected to the measuring transducer. Under the aforementioned name, “Memosens,” the applicant markets sensors for measuring pH value, conductivity, oxygen, turbidity, and other things. The measuring transducer can also be an integral part of the sensor.

The measurement principle implemented in sensors can often be used in more applications than originally provided. For example, a turbidity sensor which was actually developed for the measurement of sludges in the field of wastewater would also be able to measure fat content in milk by using the measurement principle. In order to be able to tap into flexible new applications, the corresponding models are not permanently stored in the sensor, but can be reloaded in the form of apps 2, in the sense of this application of sub-apps (specifically sub-app 2a, see below). The app 2 is thus a (re-)loadable piece of program code which offers additional or different functions to the measuring transducer 1.

Thus, also sensors which have already been produced are able, without a firmware update, to operate new applications. Likewise, customers who want to use their sensor for a different application can easily modify them. The ability to reload the computing models makes it possible to use highly specialized computing models which are optimized, where appropriate, only to a single measurement point. The firmware of the individual subsystems is therefore designed such that apps can be received, (internally) stored, and executed via an interface.

It is likewise possible to make a sensor 100 connectable to the measuring transducer 1 in the first place via a sub-app 2 or to make it compatible in a simple manner, for example, because the firmware did not yet support the sensor when the measuring transducer was delivered. This means that a “conversion of a first type to a second type” also includes an initial configuration or the initial commissioning.

In FIG. 2, the measuring transducer 1 is connected to the sensor 100 via a cable 111. The raw measured values of the sensor 100 are processed in the measuring transducer 1, e.g., averaged an/or converted by means of a computation model to another variable, for example, the process variable to be determined, and possibly transmitted, to a control system, for example. The measuring transducer 1 comprises a data processing unit 14 with a memory 5 that is large enough to store a plurality of apps or sub-apps. Such a sub-app for a sensor (reference sign 2a) could contain a model, meaning, for instance, the algorithm for a turbidity sensor for converting raw measured value into the actual turbidity value. The model is dependent on the application and boundary conditions, for example the installation conditions. If the sensor is used in another application, a different model and thus a different app must be selected.

The sensor 100 comprises a first physical interface 103 via which the sensor 100 is connected to the measuring transducer 1 and thereby exchanges data (bidirectionally) and is supplied with energy (unidirectionally). The cable 111 is part of a connection element 110 which can be connected at one end to the measuring transducer 1 and at the other end to the sensor 100. At the sensor-side end, the cable 111 has a second physical interface 113 complementary to the first physical interface 103. The physical interfaces 103, 113 are designed for instance as electrically isolated, or inductive, interfaces. The physical interfaces 103, 113 can be coupled to each other by means of a mechanical plug connection. The mechanical plug connection is hermetically sealed, such that no fluid, such as the medium to be measured, air, or dust can enter from the outside.

The sensor 100 comprises at least one sensor element 104 for detecting a measurand of process automation. The sensor 100 is then for example a pH sensor, also known as ISFET, generally an ion-selective sensor, a sensor for measuring the redox potential, from the absorption of electromagnetic waves in the medium, for example with wavelengths in the UV, IR and/or visible ranges, of oxygen, conductivity, turbidity, the concentration of non-metallic materials, or temperature with the particular measurand.

The sensor 100 further comprises a first coupling body 102, which comprises the first physical interface 103. The connection element 110 comprises a second, cylindrical coupling body 112 that is designed to be complementary to the first coupling body 102 and can be slipped with a sleeve-like end portion onto the first coupling body 102, wherein the second physical interface 113 is plugged into the first physical interface 103.

The sensor 100 comprises a data processing unit 105, such as a microcontroller, which processes the raw values of the measurand obtained by the detection hardware integrated into the sensor 100 and, for example, converts them into a different data format. The data processing unit 105 is designed for energy and space reasons to usually be rather small or economical with respect to the computing capacity and the memory volume. It is therefore often only intended for “simple” computational operations, for instance for digital conversion, preprocessing, and averaging. The data processing unit 105 converts the value that depends on the measurand (i.e., the measurement signal of the sensor element 104) into a protocol that the measuring transducer 1 can understand.

The connection element 110 can comprise a data processing unit 115. The data processing unit 105 is designed to be “small” and can serve as a repeater for the data.

Several sensors 100 can also be connected to a measuring transducer 1b. Shown in FIG. 2b are two sensors 100, wherein only one of the two is provided with all of the reference signs. The same or different sensors can be connected. The left-hand one of the two is shown in the plugged-in state. Up to eight sensors can be connected to the measuring transducer 1, for example.

The measuring transducer 1 can be connected to a superordinate unit, such as a control system, via a cable. The measuring transducer 1 forwards the measurement data to a control system. In this case, the control system is designed as a process control system (PLC), PC, or server. For this purpose, the measuring transducer 1 transmits the data via a communication protocol that the control system can understand, for example a fieldbus, such as HART, Profibus PA, Profibus DP, Foundation Fieldbus, Modbus RS485, or also an Ethernet-based fieldbus, such as EtherNet/IP, Profinet, or Modbus/TCP. This case is not shown here.

The measuring transducer 1 is connected via the cable 21 to an edge device 20. Data are forwarded to the cloud 30 via the edge device 20.

The measuring transducer 1 comprises a display 7 and one or more operating elements 8, e.g., knobs or rotary knobs, buttons or soft keys, via which the measuring transducer 1 can be operated. Measured data, for example, of the sensor 100 are displayed by the display 7. The sensor 100 can also be configured and parameterized by means of the operating elements 8 and the corresponding view on the display 7. The display 7 can also be designed as a touch display; the operating elements 8 can then also be part of the touch display, viz., as touch operating elements. The measuring transducer 1 comprises the data processing unit 14. The measuring transducer 1 can also comprise an SD card slot 9 via which apps 2 can be loaded onto the measuring transducer 1. The measuring transducer 1 can also comprise one or more wireless modules 10, such as Bluetooth, mobile radio (2G, 3G, 4G, 5G) or other, possibly also wireless, bus protocols, such as WirelessHART.

The functionality of the measuring transducer 1 can be expanded via one or more apps, primarily sub-apps (reference sign 2b). The apps are located in the memory 5 and are transmitted via a communication interface to the measuring transducer 1. Depending on the design of the measuring transducer 1, the app(s) can be transmitted to the measuring transducer 1, for example, via a wireless data connection (see reference sign 10), such as Bluetooth or the like. The apps can also be loaded via a memory card, e.g., an SD card (see reference sign 9), into the data processing unit 14 if the measuring transducer 1 comprises such an option. It is also possible to transmit the app via the edge device 20 or a bus system (such as HART, WirelessHART, Modbus, Foundation Fieldbus, or similar; not shown) and the corresponding wireless or wired connection line.

As mentioned, the measuring transducer 1 or the sensors 100 connected thereto can be operated and parameterized via the operating elements 8. To this end, a menu or the menu structure is shown on the display 7. The menu structure describes the hierarchy, navigation, and texts of the various menu pages that are shown on the display 7. The menu structure makes it possible to select the desired command from an offering and to have it executed.

So that the switch from the first application (measuring system of the first type) to a second application (measuring system of the second type) can be switched, each subsystem of the measuring system 200 must be app-capable in itself. Each subsystem is thus able to receive, install, and execute apps. Each subsystem can be expanded in its scope by apps or can be made able to run at all via apps.

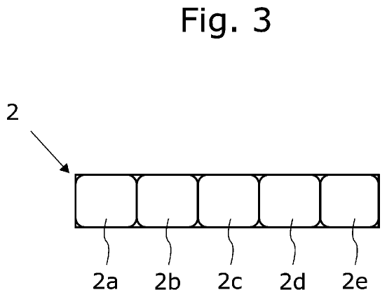

Therefore, a sub-app is developed for each subsystem, wherein the sub-apps are specific to the measuring system of the second type. The sub-apps are denoted by the reference numerals 2a-e. This is shown in FIG. 3. In this case, the sub-app 2a is the app for the sensor, the sub-app 2b is the app for the measuring transducer, the sub-app 2c is the app for the edge device, the sub-app 2d is the app for the cloud backend, and the sub-app 2s is the app for the end application. If the sub-apps 2a-e are created, a common multipart app 2 is created.

A multipart app 2 always contains all the necessary sub-apps. However, it could be the case that a sub-app is contained identically in multiple multipart apps.

In one embodiment, a sub-app already installed on a subsystem is not installed again. For this purpose, for example, each sub-app is assigned a unique identification feature (e.g. a hash/a checksum over the sub-app). Each subsystem knows the identification feature of its installed sub-app. During the installation attempt a sub-app, the identification feature of the currently installed sub-app is queried from the target system. If the identification feature of the installed sub-app is the same as the identification feature of the sub-app to be installed, it is not installed again.

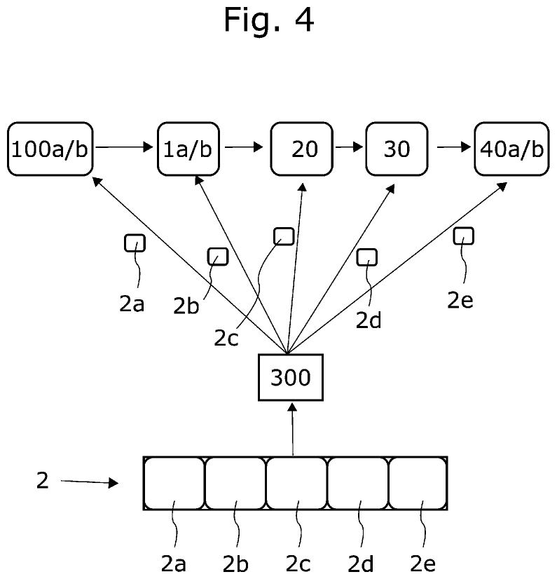

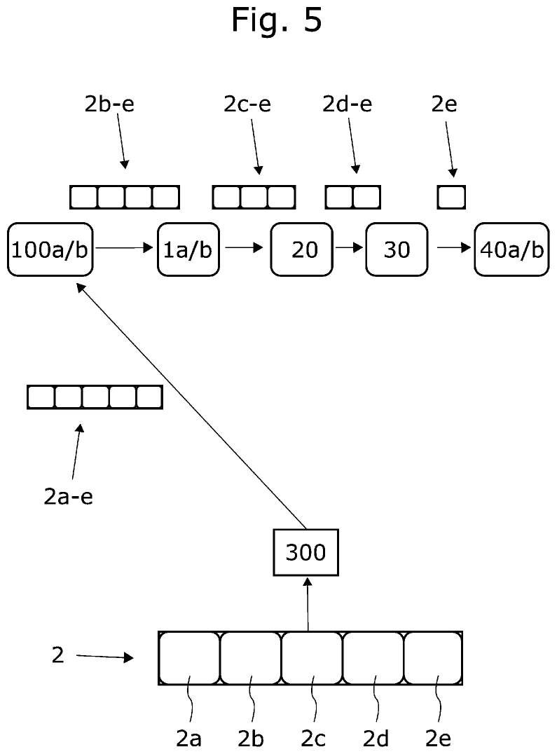

Finally, the multipart app 2 has to be distributed to the respective subsystems, i.e., be installed onto the measuring system 200. There are two possibilities: the central approach, see FIG. 4, and the end point approach, see FIG. 5.

In the central approach in FIG. 4, the multipart app 2 is split by a central system 300 into its sub-apps 2a-e, and the sub-apps 2a-e are transmitted to the respective systems. The reference signs 100a/b, 1a/b and 40a/b, respectively, indicate that the first type (“a”) is installed before the installation and the second type (“b”) is installed after the installation.

The central system 300 is, for example, a control system or a computer of the end user.

In the end point approach in FIG. 5, the multipart app 2 is transmitted a central system 300 (control system or computer of the end user) to a subsystem in the measuring system 200. This can be the start or end subsystem; the start subsystem is shown. Each subsystem of the measuring system 200 installs its associated sub-app 2a-e and forwards the remaining sub-apps to the next subsystem. In one embodiment, the entire multipart app 2 is not forwarded, but only the non-stored/non-installed part. Each subsystem installs “its” sub-app and forwards the rest.

In the embodiments in FIG. 3-5, the multipart app 2 comprises five sub-apps 2a-e for exactly five subsystems, which then make up the overall system, i.e., the measuring system 200. An embodiment is also possible in which, although the multipart app 2 comprises five sub-apps 2a-e, the measuring system 200 consists of fewer than five subsystems. For example, the measuring system 200 does not comprise an edge device. Then, the multipart app 2 is still distributed and installed with the five sub-apps 2a-e—the “missing” subsystem is simply not used in the central approach. In the distributed approach, the “missing” subsystem is skipped.

In the central approach in FIG. 4, the multipart app 2 is split by a central system 300 into its sub-apps 2a-e, and the sub-apps 2a-e are transmitted to the respective systems. The reference signs 100a/b, 1a/b and 40a/b, respectively, indicate that the first type (“a”) is installed before the installation and the second type (“b”) is installed after the installation.

The central system 300 is, for example, a control system or a computer of the end user.

In the end point approach in FIG. 5, the multipart app 2 is transmitted a central system 300 (control system or computer of the end user) to a subsystem in the measuring system 200. This can be the start or end subsystem; the start subsystem is shown. Each subsystem of the measuring system 200 installs its associated sub-app 2a-e and forwards the remaining sub-apps to the next subsystem. In one embodiment, the entire multipart app 2 is not forwarded, but only the non-stored/non-installed part. Each subsystem installs “its” sub-app and forwards the rest.

In the embodiments in FIG. 3-5, the multipart app 2 comprises five sub-apps 2a-e for exactly five subsystems, which then make up the overall system, i.e., the measuring system 200. An embodiment is also possible in which, although the multipart app 2 comprises five sub-apps 2a-e, the measuring system 200 consists of fewer than five subsystems. For example, the measuring system 200 does not comprise an edge device. Then, the multipart app 2 is still distributed and installed with the five sub-apps 2a-e—the “missing” subsystem is simply not used in the central approach. In the distributed approach, the “missing” subsystem is skipped.

1. A method for converting a measuring system of a first type to a second type,
wherein the measuring system includes at least two subsystems, including a sensor and an end application,
wherein each subsystem is designed to be app-capable such that the firmware of each subsystem is designed to receive, install, and execute apps,
the method comprising the steps of:
creating sub-apps for the respective subsystem, wherein the sub-apps are specific to the measuring system of the second type;
creating a multipart app including all sub-apps; and
installing the multipart app onto the measuring system.

2. The method according to claim 1,
wherein the multipart app is installed by a central system and is distributed from there to the subsystems.

3. The method according to claim 2,
wherein the multipart app is split by the central system into the sub-apps and the sub-apps are transmitted to the respective subsystems.

4. The method according to claim 2,
wherein the multipart app is transmitted from the central system to a first subsystem, the first subsystem installs its sub-app, and forwards the multipart app to the second subsystem, where the respective sub-app is then installed.

5. The method according to claim 4,
wherein the first subsystem forwards only the non-installed part.

6. The method according to claim 1,
wherein the multipart app is installed on a subsystem and is distributed from there to the other subsystems.

7. The method according to claim 6,
wherein the installation takes place using a memory card.

8. The method according to claim 6,
wherein the sub-app of the subsystem on which the multipart app has been installed is installed on the same.

9. The method according to claim 6,
wherein the multipart app is split by the subsystem on which the multipart app was installed into the sub-apps and the sub-apps are transmitted to the respective other subsystems.

10. The method according to claim 6,
wherein the multipart app is transmitted from the subsystem on which the multipart app was installed to a further subsystem, this subsystem installs its sub-app, and forwards the multipart app to another subsystem, where the respective sub-app is then installed.

11. The method according to claim 10,
wherein the respective subsystem forwards only the non-installed part.

12. The method according to claim 1,
wherein the sub-app is not installed again if it is already present on the corresponding subsystem in the same version as the newly installable one.

13. The method according to claim 1,
wherein the multipart app comprises more sub-apps than there are subsystems.

14. The method according to claim 1,
wherein a sub-app comprises at least one of the following tasks: signal processing, user interface for configuration and interaction, visualization, data transformation to a superordinate system.

15. A measuring system designed to convert from a first type to a second type, including:
at least two subsystems, including a sensor and an end application, wherein each subsystem is designed to be app-capable such that the firmware of each subsystem is designed to receive, install, and execute apps,
wherein the measuring system is designed to execute the following steps:
create sub-apps for the respective subsystem, wherein the sub-apps are specific to the measuring system of the second type;
create a multipart app including all sub-apps; and
install the multipart app onto the measuring system.

16. The measuring system according to claim 15,
wherein the measuring system comprises the sensor, measuring transducer, edge device, cloud, and end application subsystems.

17. A non-transitory computer readable storage medium storing instructions that, when executed by a measuring system, cause the measuring system to perform a method,
wherein the measuring system includes at least two subsystems, including a sensor and an end application,
wherein each subsystem is designed to be app-capable such that the firmware of each subsystem is designed to receive, install, and execute apps,
the method comprising the steps of:
creating sub-apps for the respective subsystem, wherein the sub-apps are specific to the measuring system of the second type;
creating a multipart app including all sub-apps; and
installing the multipart app onto the measuring system.

18. The non-transitory computer readable storage medium of claim 17,
wherein the measuring system comprises the sensor, measuring transducer, edge device, cloud, and end application subsystems.
